(19) United States
(12) Patent Application Publication
(10) Pub. No.: US 2019/0362727 A1
(43) Pub. Date: Nov. 28, 2019

(54) METHOD FOR PROVIDING BIDIRECTIONAL COMMUNICATION SERVICE FOR DIFFERENT BREEDS OF ANIMALS

(71) Applicant: Dong Whan LEE, Seoul (KR)

(72) Inventor: Dong Whan LEE, Seoul (KR)

(21) Appl. No.: 16/476,818

(22) PCT Filed: Jan. 15, 2018
(86) PCT No.: PCT/KR2018/000671

§ 371 Date: Jul. 9, 2019

(30) Foreign Application Priority Data
Jan. 18, 2017 (KR) 10-2017-0008883

(51) Int. Cl. G10L 17/26; A01K 29/00; A01K 11/00; G10L 25/63

(52) U.S. Cl. CPC G10L 17/26; G10L 25/63; A01K 11/006; A01K 29/005

(57) ABSTRACT

Provided is a method for providing a bidirectional communication service for different breeds of animals, comprising the steps of: receiving, from a user terminal, a registration event for registering a communication terminal for different breeds of animals that is wirelessly linked to the user terminal and is mounted to a communication object, and storing the same; when sound data is collected from the communication terminal for different breeds of animals, analyzing the sound data on the basis of a pre-stored animal sound translation algorithm; transmitting, to the user terminal, an animal content comprising at least one of text, a voice, an image, and a moving image mapped to the analysis result, or at least one combination thereof; when a human being content comprising at least one of a voice, an image, and a moving image is collected from the user terminal, outputting the collected human being content to a content input/output apparatus linked to the user terminal and the communication terminal for different breeds of animals; and streaming, to the user terminal, a real-time image collected from the content input/output apparatus.

### TECHNICAL FIELD

The present invention relates to a method of providing bidirectional communication services for animals. More particularly, the present invention relates to a method of detecting notes, intervals, and scales included in the sounds of an animal, analyzing the emotion of the animal by normalizing the notes, the intervals, and the scales using transposition, and determining the state of the analyzed emotion according to the intensities of the normalized notes, intervals, and scales and the sustainment time thereof.

### BACKGROUND ART

In recent years, devices and programs for analyzing animal sounds have been developed along with progress of studies to understand the emotional states of animals based on animal sounds. However, these devices and programs are only capable of grasping animal emotions sufficient to satisfy user's curiosity, and a method of accurately analyzing animal emotions has not yet been developed.

Conventionally, animal sounds are analyzed through frequency analysis. In this regard, Korean Patent No. 10-1413043 (published on Jul. 14, 2014), which is related art, discloses a configuration, in which, when the frequency characteristics of the sounds of a pet are analyzed and the analyzed result is judged to match a predetermined specific state, a video telephone connection is automatically attempted on a user terminal, the image information of the user is output on the screen of the electronic device or the display, and a color spectrum image which changes in a predetermined period around the image information is provided.

However, in the case of analyzing the frequency characteristics from the voice information of a pet, accurate analysis is difficult when there is sounds according to emotions in which frequencies overlap. In addition, to analyze emotions correctly, it is required to normalize frequencies or sounds that vary depending on species, ages, and body information as well as frequencies. However, the conventional method does not include such a normalization process, and thus accurate analysis is not easy with the existing method.

### DISCLOSURE

### Technical Problem

Therefore, the present invention has been made in view of the above problems, and it is one object of the present invention to provide a method of providing bidirectional communication services for animals. According to the method of the present invention, firstly, emotions are analyzed using intervals, notes, and scales. In this case, to perform patterning and normalization of diversity that changes according to body information including breed, a transposition process is performed, and then emotions are analyzed. Secondly, the dynamics and sustainment time of sounds are analyzed to extract the dynamics of emotions, allowing accurate analysis. Here, the technical problems to be solved by the present invention is not limited to the technical problems as described above, and other technical problems may exist.

### Technical Solution

In accordance with one aspect of the present invention, provided is a method of providing bidirectional communication services for animals including a step of receiving a registration event for guiding registration of an animal communication terminal, which is wirelessly interconnected with a user terminal and mounted on a communication subject, from the user terminal and storing the registration event; a step, in which, when sound data is collected from the animal communication terminal, the sound data is analyzed based on a pre-stored animal sound translation algorithm; a step of transmitting animal content including at least one or at least one combination of text, voice, images, and moving pictures mapped in the analysis results to the user terminal; a step, in which, when human content including at least one of voice, images, and moving pictures is collected from the user terminal, the collected human content is output to a content input/output device interconnected with the user terminal and the animal communication terminal; and a step of streaming real-time images collected from the content input/output device to the user terminal.

### Advantageous Effects

According to any one of the above-mentioned technical solutions of the present invention, firstly, emotions are analyzed using intervals, notes, and scales. In this case, to perform patterning and normalization of diversity that changes according to body information including breed, a transposition process is performed, and then emotions are analyzed. Secondly, the dynamics and sustainment time of sounds are analyzed to extract the dynamics of emotions, allowing accurate analysis.

### DESCRIPTION OF DRAWINGS

FIG. 1 is a schematic diagram for explaining a system for providing bidirectional communication services for animals according to one embodiment of the present invention.

FIG. 2 is a block diagram for explaining the animal bidirectional communication service providing server shown in FIG. 1.

FIG. 3 is a block diagram for explaining the animal communication terminal shown in FIG. 1.

FIG. 4 is a drawing for explaining an embodiment in which the animal communication terminal shown in FIG. 1 is implemented as a band type.

FIG. 5 is a drawing for explaining an embodiment in which the animal communication terminal shown in FIG. 1 is implemented as a clip type.

FIG. 6 is a drawing for explaining an embodiment in which bidirectional communication services for animals are implemented in the user terminal shown in FIG. 1.

FIG. 7 is a graph for explaining a pre-transposition process in an animal sound translation algorithm of the bidirectional communication service for animals according to one embodiment of the present invention.

FIG. 8 is a graph for explaining a transposition process in an animal sound translation algorithm of the bidirectional communication service for animals according to one embodiment of the present invention.

FIG. 9 includes graphs for explaining a process of subdividing emotions depending on dynamics and sustainment time in an animal sound translation algorithm of the bidirectional communication service for animals according to one embodiment of the present invention.

FIG. 10 includes drawings for explaining waveforms and notes for distinguishing emotions of anxiety in an animal sound translation algorithm of the bidirectional communication service for animals according to one embodiment of the present invention.

FIG. 11 includes drawings for explaining waveforms and notes for distinguishing emotions of loneliness in an animal sound translation algorithm of the bidirectional communication service for animals according to one embodiment of the present invention.

FIG. 12 includes drawings for explaining waveforms and notes for distinguishing emotions of pleasure in an animal sound translation algorithm of the bidirectional communication service for animals according to one embodiment of the present invention.

FIG. 13 includes drawings for explaining waveforms and notes for distinguishing emotions of wariness in an animal sound translation algorithm of the bidirectional communication service for animals according to one embodiment of the present invention.

FIG. 14 includes drawings for explaining waveforms and notes for distinguishing emotions of anger in an animal sound translation algorithm of the bidirectional communication service for animals according to one embodiment of the present invention.

FIG. 15 is a drawing for explaining frequency ranges according to emotions in an animal sound translation algorithm of the bidirectional communication service for animals according to one embodiment of the present invention.

FIG. 16 is a drawing for explaining emotions and sound patterns in the bidirectional communication service for animals according to one embodiment of the present invention.

FIG. 17 is an operation flowchart for explaining an embodiment for extracting emotions of depression using an animal sound translation algorithm of the bidirectional communication service for animals according to one embodiment of the present invention.

FIG. 18 is an operation flowchart for explaining a method of providing bidirectional communication services for animals according to one embodiment of the present invention.

### BEST MODE

Exemplary embodiments of the present invention are described in detail so as for those of ordinary skill in the art to easily implement with reference to the accompanying drawings. However, the present invention may be implemented in various different forms and is not limited to these embodiments. To clearly describe the present invention, a part without concerning to the description is omitted in the drawings, and the same or similar elements are designated with the same drawing symbols in the entire specification.

It should be understood that when an element is referred to as being “connected to” or “coupled to” another element, the element may be directly connected or coupled to the other element or intervening elements may be present. In addition, it is to be understood that, unless otherwise stated, when a part “comprises” any element, the part may include other elements without excluding other elements. Also, terms such as “include” or “comprise” should be construed as denoting that a certain characteristic, number, step, operation, constituent element, component or a combination thereof exists and not as excluding the existence of or a possibility of an addition of one or more other characteristics, numbers, steps, operations, constituent elements, components or combinations thereof.

Terms “about”, “substantially”, and the like used throughout the specification mean close to a numerical value when tolerance is present in the stated meaning, and are used to prevent unauthorized persons from exploiting the disclosure in which exact or absolute numerical values are mentioned to facilitate understanding of the present invention. The terms “step of ˜” used in this specification does not mean “step for ˜”.

In this specification, “part (unit)” includes a unit includes a unit implemented by hardware, a unit implemented by software, and a unit implemented by both. In addition, one unit may be realized using two or more hardware, and two or more units may be realized by one hardware.

In this specification, some of operations or functions performed by a terminal, an apparatus, or a device may be performed in a server connected to the terminal, the apparatus, or the device. Likewise, some of operations or functions performed by the server may also be performed in the terminal, the apparatus, or the device connected to the server.

In this specification, some of operations or functions described by mapping or matching with a terminal can be interpreted as mapping or matching the unique number of the terminal, which is the identification information of the terminal, or the identification information of an individual.

Hereinafter, the present invention will be described in detail with reference to the accompanying drawings.

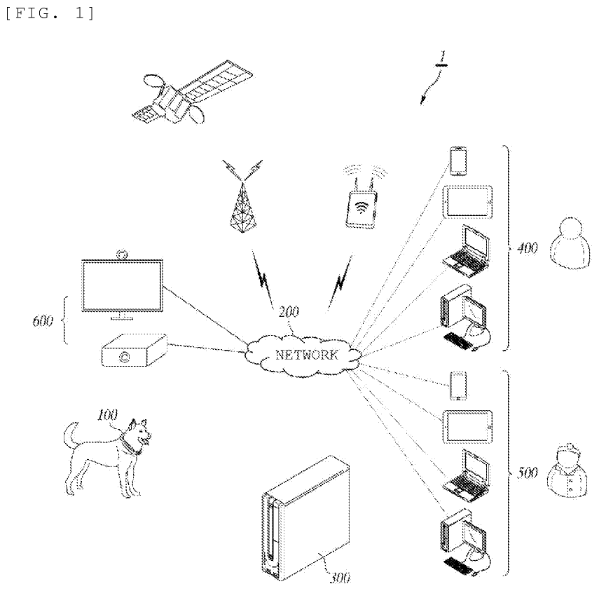

FIG. 1 is a schematic diagram for explaining a system for providing bidirectional communication services for animals according to one embodiment of the present invention. Referring to FIG. 1, a system for providing bidirectional communication services for animals 1 may include an animal communication terminal 100, an animal bidirectional communication service providing server 300, a user terminal 400, and a veterinarian terminal 500. However, since the system for providing bidirectional communication services for animals 1 of FIG. 1 is only an embodiment of the present invention, the present invention is not limited to FIG. 1.

In this case, the components shown in FIG. 1 are generally connected via a network 200. For example, as shown in FIG. 1, the animal communication terminal 100 may be connected to the user terminal 400 via the network 200. In addition, the animal communication terminal 100 may be connected to the animal bidirectional communication service providing server 300 via the network 200. In addition, the animal bidirectional communication service providing server 300 may be connected to the animal communication terminal 100, the user terminal 400, and the veterinarian terminal 500 via the network 200. In addition, the user terminal 400 may be connected to the animal communication terminal 100 via the network 200. In addition, the user terminal 400 may be connected to the animal bidirectional communication service providing server 300 via the network 200. In addition, the veterinarian terminal 500 may be connected to the animal bidirectional communication service providing server 300 and to the animal communication terminal 100 and the user terminal 400 via the network 200.

In this case, the network 200 refers to a connection structure capable of exchanging information between nodes such as terminals and servers. For example, the network 200 includes a 3rd Generation Partnership Project (3GPP) network, a Long Term Evolution (LTE) network, a 5rd Generation Partnership Project (SGPP) network, a World Interoperability for Microwave Access (WIMAX) network, Internet, a local area network (LAN), a wireless local area network (WLAN), a wide area network (WAN), a personal area network (PAN), a Bluetooth network, a satellite broadcasting network, an analog broadcasting network, a digital multimedia broadcasting (DMB) network, and the like, without being limited thereto. The animal communication terminal 100, the animal bidirectional communication service providing server 300, the user terminal 400, and the veterinarian terminal 500 are not limited by the configuration shown in FIG. 1.

The animal communication terminal 100 may be a terminal including an input/output device and a sensor for communicating with the user terminal 400 and may be worn by a communication subject. In addition, the animal communication terminal 100 may be a terminal for capturing a view of a direction that a communication subject is viewing and a view of a direction toward the communication subject and for recording the sounds of the communication subject and transmitting the sounds to the animal bidirectional communication service providing server 300 and the user terminal 400. In addition, the animal communication terminal 100 may be a terminal connected to a wireless or wired network and responsible for outputting content input from a communication subject and outputting content transmitted to the communication subject. In addition, the animal communication terminal 100 may be a terminal for outputting ultrasonic waves using GPS position information to drive out pests. In addition, the animal communication terminal 100 may be a terminal including a device emitting light at a predetermined illuminance or less through solar power generation or kinetic energy generation. In addition, the animal communication terminal 100 may be a terminal for converting a message of the user terminal 400 into a sound of a communication subject and outputting the sound. In addition, the animal communication terminal 100 may be a terminal for transmitting content input from the user terminal 400 to the network 200 so that a content input/output device 600 disposed close to the animal communication terminal 100 outputs the content. In this case, the animal communication terminal 100 may be a terminal for outputting an emotion index and content through a display.

In this case, the animal communication terminal 100 may be installed in each sector within audible limits to extract a signal pattern according to a predetermined sound in an animal breeding facility. In addition, the animal communication terminal 100 may be configured to monitor animals in real time for disease prevention and early disease detection. That is, when a cough sound indicating illness, an onomatopoeic sound, a mutual communication sound, or a sound indicating pain among a plurality of animal sounds has a sound signal pattern identical to a specific sound signal pattern, the animal communication terminal 100 may extract the sound.

In this case, the animal communication terminal 100 may be a device having a separate GPS function, a location information transmission function, and a function of communicating with the animal communication terminal 100. The animal communication terminal 100 may be implemented as a terminal capable of being connected to a remote server or terminal through the network 200. In addition, the animal communication terminal 100 may include handheld and portable wireless communication devices such as a navigation system, a Personal Communication System (PCS), a Global System for Mobile Communications (GSM), a Personal Digital Cellular (PDC) system, a Personal Handy-phone System (PHS), a Personal Digital Assistant (PDA), International Mobile Telecommunications-2000 (IMT-2000), Code Division Multiple Access-2000 (CDMA-2000), W-Code Division Multiple Access (W-CDMA), a Wireless Broadband (WiBro) terminal, a smartphone, a smartpad, and a tablet PC.

The animal bidirectional communication service providing server 300 may be a server for analyzing sounds input from the animal communication terminal 100 using a pre-stored animal sound translation algorithm and transmitting content mapped in the analyzed sounds to the user terminal 400. In addition, the animal bidirectional communication service providing server 300 may be a server for analyzing sounds according to animal species or for each individual and patterning the sounds, performing machine learning and deep learning using big data, and then providing information about the sounds like artificial intelligence. In addition, the animal bidirectional communication service providing server 300 may be a server for connecting the veterinarian terminal 500 and the user terminal 400 and transmitting information received from the animal communication terminal 100 to the veterinarian terminal 500. In addition, the animal bidirectional communication service providing server 300 may be a server for transmitting information received from the veterinarian terminal 500 to the user terminal 400. In addition, the animal bidirectional communication service providing server 300 may be a server for receiving information about a recognized situation between a communication subject and a user, performing learning about the received data, and transmitting the learned data to the user terminal 400. Accordingly, when a sound is received from a communication subject for a recognized situation between a user and the communication subject, the user terminal 400 may output mapped information. In addition, the animal bidirectional communication service providing server 300 may be a server including an animal sound translation algorithm for analyzing animal sounds using notes, intervals, and scales, performing transposition, and classifying the sounds into specific meanings. In this case, the animal sound translation algorithm may measure dynamics and sustainment time and classify emotions in detail according to dynamics and sustainment time. In addition, the animal bidirectional communication service providing server 300 may be implemented as a computer capable of being connected to a remote server or terminal through the network 200. In this case, the computer may include, for example, a laptop with a web browser, a desktop, and the like.

The user terminal 400 may be a terminal using web pages, app pages, programs, or applications provided from the animal bidirectional communication service providing server 300. In addition, the user terminal 400 may be a terminal that is connected to the animal communication terminal 100 via the animal bidirectional communication service providing server 300 or is directly connected to the animal communication terminal 100. In addition, the user terminal 400 may be a terminal for analyzing sounds output from the animal communication terminal 100 and outputting matched text and the like. In addition, the user terminal 400 may be a terminal that receives feedback from the veterinarian terminal 500. In addition, the user terminal 400 may be a terminal for inputting perceived data between an animal and a person. In addition, the user terminal 400 may be a terminal for transmitting a sound converted into an animal language to the animal communication terminal 100 when text is input in a human language.

In this case, the user terminal 400 may be a device having a separate GPS function, a location information transmission function, and a function of communicating with the user terminal 400, and may be implemented as a terminal capable of being connected to a remote server or terminal through the network 200. In addition, the user terminal 400 may include handheld and portable wireless communication devices such as a navigation system, a Personal Communication System (PCS), a Global System for Mobile Communications (GSM), a Personal Digital Cellular (PDC) system, a Personal Handy-phone System (PHS), a Personal Digital Assistant (PDA), International Mobile Telecommunications-2000 (IMT-2000), Code Division Multiple Access-2000 (CDMA-2000), W-Code Division Multiple Access (W-CDMA), a Wireless Broadband (WiBro) terminal, a smartphone, a smartpad, and a tablet PC.

The veterinarian terminal 500 may be a terminal for transmitting diagnosis data to the user terminal 400 using biometric signals and image data received from the animal communication terminal 100. In addition, the veterinarian terminal 500 may be a terminal using web pages, app pages, programs, or applications provided from the animal bidirectional communication service providing server 300. In this case, the veterinarian terminal 500 may be a terminal for controlling rotation and tilting of a camera installed in the animal communication terminal 100. In this case, the veterinarian terminal 500 may be a device having a separate GPS function, a location information transmission function, and a function of communicating with the veterinarian terminal 500, and may be implemented as a terminal capable of being connected to a remote server or terminal through the network 200. In addition, the veterinarian terminal 500 may include handheld and portable wireless communication devices such as a navigation system, a Personal Communication System (PCS), a Global System for Mobile Communications (GSM), a Personal Digital Cellular (PDC) system, a Personal Handy-phone System (PHS), a Personal Digital Assistant (PDA), International Mobile Telecommunications-2000 (IMT-2000), Code Division Multiple Access-2000 (CDMA-2000), W-Code Division Multiple Access (W-CDMA), a Wireless Broadband (WiBro) terminal, a smartphone, a smartpad, and a tablet PC.

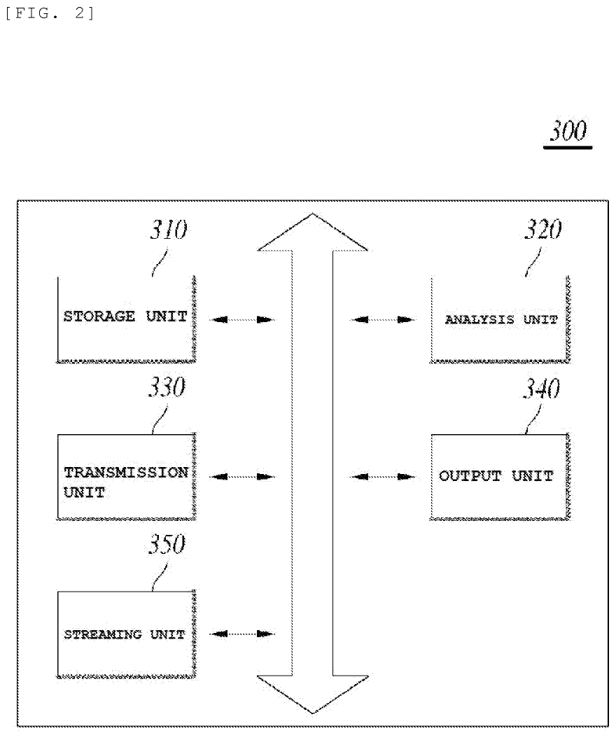

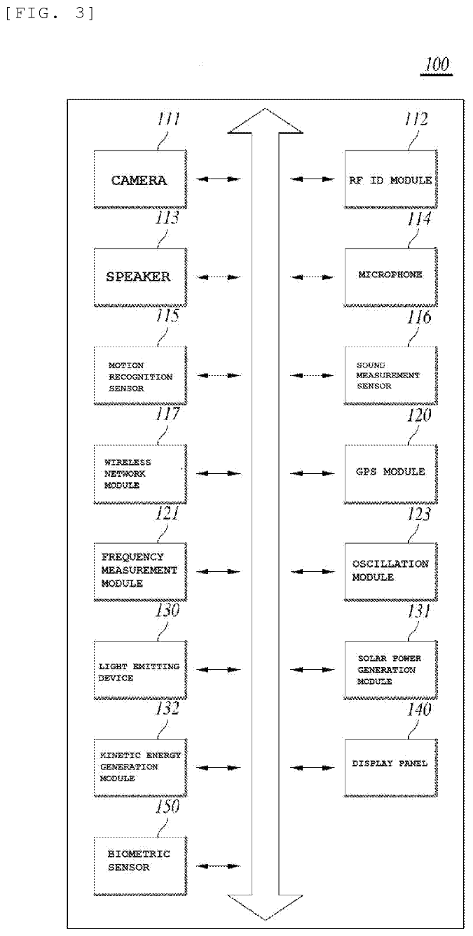

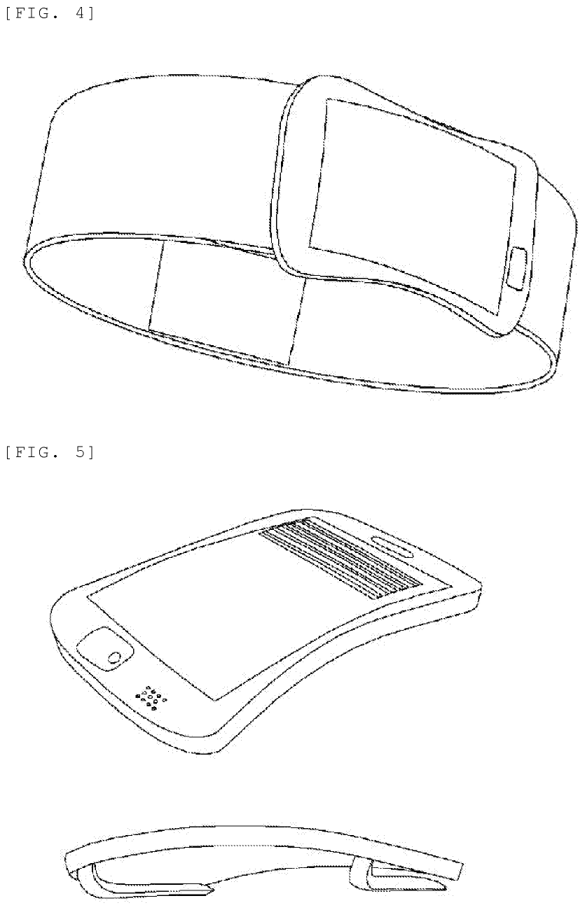

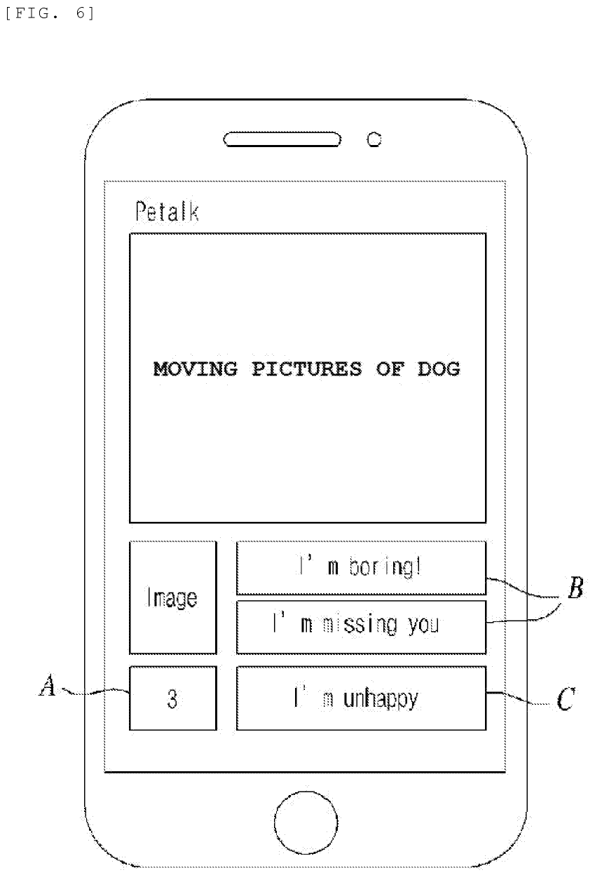

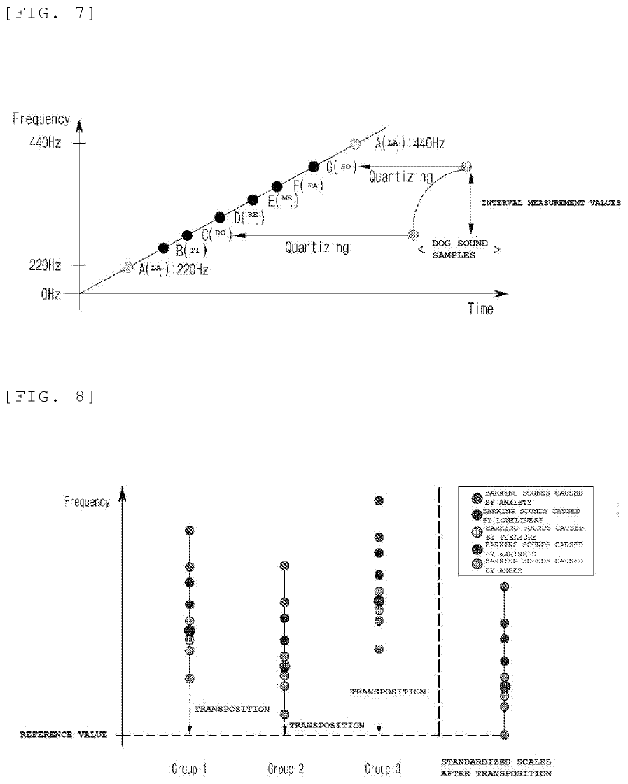

FIG. 2 is a block diagram for explaining the animal bidirectional communication service providing server shown in FIG. 1, FIG. 3 is a block diagram for explaining the animal communication terminal shown in FIG. 1, FIG. 4 is a drawing for explaining an embodiment in which the animal communication terminal shown in FIG. 1 is implemented as a band type, FIG. 5 is a drawing for explaining an embodiment in which the animal communication terminal shown in FIG. 1 is implemented as a clip type, and FIG. 6 is a drawing for explaining an embodiment in which bidirectional communication services for animals are implemented in the user terminal shown in FIG. 1.

Referring to FIG. 2, the animal bidirectional communication service providing server 300 according to one embodiment of the present invention may include a storage unit 310, an analysis unit 320, a transmission unit 330, an output unit 340, and a streaming unit 350. In addition, referring to FIG. 3, the animal communication terminal 100 may include a camera 111, an RFID module 112, a speaker 113, a microphone 114, a motion perception center 115, a sound measurement sensor 116, a wireless network module 117, a GPS module 120, a frequency measurement module 121, an oscillation module 123, a light emitting device 130, a solar power generation module 131, a kinetic energy oscillation module 132, a display panel 140, and a biometric sensor 150.

When the animal bidirectional communication service providing server 300 according to one embodiment of the present invention or another server (not shown) operating in conjunction with the animal bidirectional communication service providing server 300 transmits animal bidirectional communication service applications, programs, app pages, web pages, or the like to the user terminal 400 and the veterinarian terminal 500, the user terminal 400 and the veterinarian terminal 500 may install or open the animal bidirectional communication service applications, the programs, the app pages, or the web pages. In addition, a service program may be executed in the user terminal 400 and the veterinarian terminal 500 using a script executed in a web browser. In this case, a web browser is a program that allows a user to use a web (World Wide Web, WWW) service, and receives and displays a hypertext described in Hyper Text Mark-up Language (HTML). For example, the web browser includes Netscape, Explorer, Chrome, and the like. In addition, an application refers to an application program on a terminal, and includes, for example, an app running on a mobile terminal (e.g., a smartphone).

In this case, connection of the network 200 indicates that a communication entity is created at a communication contact for communication with the animal communication terminal 100, the animal bidirectional communication service providing server 300, the user terminal 400, and the veterinarian terminal 500, which are connected through the network 200. The animal bidirectional communication service providing server 300 may exchange data with other components through the communication entity.

The storage unit 310 may be wirelessly interconnected with the user terminal 400, and may receive a registration event for guiding registration of the animal communication terminal 100 mounted on a communication subject from the user terminal 400 and store the registration event.

When sound data is collected from the animal communication terminal 100, the analysis unit 320 may analyze the sound data based on a pre-stored animal sound translation algorithm. In this case, the pre-stored animal sound translation algorithm may be an algorithm for detecting and analyzing the notes, intervals, and scales of sound data, performing transposition, and then extracting emotions by comparing with pre-stored reference data of a communication subject. Here, emotions may include anxiety, loneliness, pleasure, wariness, and anger.

In addition, a frequency band included in reference data for anxiety may be 1,108.8 Hz to 1,568 Hz, and an interval included in the reference data for anxiety may be decreased by minor 2nd to minor 3rd with respect to an initial note. In addition, a frequency band included in reference data for loneliness may be 493 Hz to 830.7 Hz, and an interval included in the reference data for loneliness may be increased by major 3rd to perfect 4th with respect to an initial note, and then may be decreased by diminished 4th to perfect 5th. In addition, a frequency band included in reference data for pleasure may be 392 Hz to 987.8 Hz, and an interval included in the reference data for pleasure may be increased by augmented 5th to major 6th with respect to an initial note.

In addition, a frequency band included in reference data for wariness may be 554.4 Hz to 659.3 Hz, and an interval included in the reference data for wariness may be increased by perfect 1st to minor 3rd with respect to an initial note. In addition, a frequency band included in reference data for anger may be 130.8 Hz to 987.4 Hz, and an interval included in the reference data for anger may be increased by perfect 4th or more with respect to an initial note, and may be further increased by perfect 8th or more with respect to the increased note.

When primary analysis of emotions is completed, a pre-stored animal sound translation algorithm may extract emotion information, and then may analyze emotions and temperament changes according to differences in intervals, sustainment time, and dynamics. In this case, the pre-stored animal sound translation algorithm will be described in detail below.

The transmission unit 330 may transmit animal content including at least one or at least one combination of text, voice, images, and moving pictures mapped in analysis results to the user terminal 400.

When human content including at least one of voice, images, and moving pictures is collected from the user terminal 400, the output unit 340 may allow the collected human content to be output in the content input/output device 600 interconnected with the user terminal 400 and the animal communication terminal 100. In this case, the content input/output device 600 may include any devices capable of inputting or outputting content, such as a beam projector, a display, a speaker, and a microphone, without being limited thereto.

The streaming unit 350 may stream real-time images collected from the content input/output device 600 to the user terminal 400.

Meanwhile, the animal communication terminal 100 may be implemented as a wearable device worn by a communication subject. In this case, the wearable device may be a wearable device that wraps a part of the body, or a clip-type wearable device. In addition, the animal communication terminal 100 may include the camera 111 for capturing a view of a direction that a communication subject is viewing and the communication subject, the RFID module 112 for forming a wireless communication channel using RFID, the speaker 113 for outputting sounds received by and input to the animal communication terminal 100, the microphone 114 for receiving the sounds of the communication subject, a motion recognition sensor 115 for sensing motions of the communication subject, the sound measurement sensor 116 for distinguishing sounds of the communication subject among sounds received from the microphone and inputting the distinguished sounds, and the wireless network module 117 for forming a channel for data transmission/reception to/from the user terminal 400 through the content input/output device and wireless communication. However, the present invention is not limited to the above-described configuration, and it is obvious that any configuration may be used as long as it may analyze the motions or sounds of a communication subject and output the feedback of a user.

In addition, the user terminal 400 may store input and output data for stimulation and response between a user and a communication subject. For example, when the communication subject is a dog, assuming that an owner has taken a walk whenever the owner picks up an object A, the dog may instinctively engage in pleasing behavior when the owner picks up the object A. Accordingly, the owner may store the action of picking up the object A and the pleasing behavior of the dog as input and output, respectively. In this case, conditions and behavior may be extracted from the user terminal 400 and stored automatically.

Accordingly, the user terminal 400 may perform patterning of the stored data through machine learning, deep learning, or artificial intelligence neural network learning. When the patterned output data is input from the animal communication terminal 100, the user terminal 400 may output communication content matched with the output data. In this case, patterning of input data and output data may be executed on the animal bidirectional communication service providing server 300. Changes may be made in accordance with implementation methods and implementation embodiments.

In addition, the animal communication terminal 100 may further include the GPS module 120, a frequency measurement sensor module 121, and the oscillation module 123. In this case, when the animal communication terminal 100 is located at a predetermined position or is adjacent to an insect generating a predetermined frequency, the animal communication terminal 100 may output two or more frequencies of 20 kHz to 20 MHz per second using the oscillation module. In addition, the output frequencies may be frequencies that do not cancel each other out, and may be oscillated in a multidirectional manner. For example, assuming that a communication subject is located in a region where harmful insects are concentrated or where harmful germs have spread, or is close to insects generating a specific frequency, the animal communication terminal 100 may oscillate at a frequency for driving away harmful insects. Accordingly, propagation of germs may be prevented and safety of a communication subject may be secured.

In addition, when a loss event of a communication subject wearing the animal communication terminal 100 is displayed on the user terminal 400, the animal bidirectional communication service providing server 300 may transmit loss content to the animal communication terminal 100 so that the animal communication terminal 100 outputs the loss content. In this case, the loss content may include a name of the communication subject, a telephone number of the user terminal, and an address, and may be output in a predetermined period or in real time. For example, when the communication subject is a cat, and the user terminal 400 recognizes that the cat has disappeared and reports loss of the cat, user's address and telephone numbers, and the like may be displayed periodically or in real time on the animal communication terminal 100, and the position of the cat may be identified in the user terminal 400 through the position information of the cat output from the GPS module 120.

In addition, the animal communication terminal 100 may include the light emitting device 130, the solar power generation module 131, and a kinetic energy generation module 132. In this case, when a measured illuminance is less than a predetermined illuminance, the solar power generation module 131 and the kinetic energy generation module 132 allow the light emitting device 130 to emit light. In this case, the intensity of the emitted light may be adjusted in the user terminal 400. For example, when the communication subject is a dog and the dog goes out for a walk or walks alone in the evening, the dog may be involved in an accident like a traffic accident due to limited field of view. In this case, the light emitting device 130 emits light to notify nearby persons or cars that there is an arbitrary object. At this time, light intensity and illuminance may be controlled via the user terminal 400.

In addition, the animal communication terminal 100 may further include the display panel 140. In this case, when input sound data is translated by a pre-stored animal sound translation algorithm, the animal communication terminal 100 may output the type and intensity of a translated emotion as content including colors, phrases, images, and moving pictures, which have been mapped and stored, and the output content may be displayed on the display panel 140. For example, when the display panel 140 is an LCD, conditions may be preset such as a pink color for a pleasant emotion and a red color for an unpleasant emotion, or a user may set the conditions. In addition, the degree of the emotion may be set to a number from 1 to 10. However, the present invention is not limited thereto, and various embodiments are possible.

In addition, the animal communication terminal 100 may further include the camera 111 and the biometric sensor 150. In this case, when a medical care request event is displayed on the user terminal 400, pre-stored data of the animal communication terminal 100 and data measured by the biometric sensor 150 may be transmitted to the veterinarian terminal 500 of a veterinarian treating a communication subject via the animal bidirectional communication service providing server 300. In this case, the veterinarian terminal 500 may control the capturing direction of the camera 111 included in the animal communication terminal 100, receive captured images in real time, and transmit feedback to the user terminal 400.

In addition, the animal communication terminal 100, the user terminal 400, and the animal bidirectional communication service providing server 300 may be interconnected based on a cloud server. In this case, the animal bidirectional communication service providing server 300 may perform data mining and learning of collected data using big data to store categorized patterns for each type, predict diseases of a communication subject, and transmit a prediction result to the user terminal 400.

Meanwhile, when text transmitted from the user terminal 400 to the animal communication terminal 100 is collected, the collected text is subjected to a reverse translation process of a pre-stored animal sound translation algorithm so that the animal bidirectional communication service providing server 300 may generate animal sounds. In addition, the animal bidirectional communication service providing server 300 may transmit the generated animal sounds to the animal communication terminal 100. Accordingly, when a user is a person and a communication subject is a dog, the voice of the dog may be analyzed and the analyzed voice may be delivered to the user. In addition, a user's text may be converted into the language of a dog, and the user's intention and emotions may be delivered to the dog.

In addition, the pre-stored animal sound translation algorithm may be based on an animal translation database that analyzes the period, frequency, pitch, vibration, pattern, and interval of animal sounds according to animal types and anatomical structures and forms a database of the analyzed results. In this case, the animal translation database may be a database that is based on the sounds of an animal wearing the animal communication terminal 100 and the feedback of the user terminal 400 and is updated to be customized using a gene learning algorithm, and the animal sound translation algorithm may be an algorithm that translates bi-directionally by performing mutual mapping on animal sounds and human sounds and storing the mapped information, and that is modified to be customized by a gene learning algorithm.

In addition, the pre-stored animal sound translation algorithm may include an algorithm for translating animal facial expression and behavior patterns. The animal bidirectional communication service providing server 300 may receive captured images of an animal from the animal communication terminal 100 or the content input/output device 600, and may identify facial expression and behavior patterns from the captured images and output information about facial expression and behavior patterns to the user terminal 400 through the animal communication terminal 100. In addition, the animal bidirectional communication service providing server 300 may receive captured images of a subject wearing the animal communication terminal 100, and may distinguish the subject wearing the animal communication terminal 100 from the captured images and identify the facial expression and behavior patterns of the distinguished subject. In addition, the identified facial expression and behavior patterns may be translated by the animal sound translation algorithm using combinations of animal sounds.

Referring to FIGS. 4 and 5, the animal communication terminal 100 may be a band type terminal configured to surround a part of the body or a clip type terminal configured to fit into an arbitrary object surrounding a part of the body. However, the present invention is not limited thereto, and any of wearable type terminals that can be attached to a communication subject is possible.

Referring to FIG. 6, A may be configured to display the emotional expression index (degree) of a communication subject as a number from 1 to 10, B may be an interface for outputting the analysis results of the behavior or sounds of a communication subject as pre-matched text, and C may be an interface for outputting phrases mapped to emotional expressions as text. However, the present invention is not limited thereto, and text may be converted into content such as images and moving pictures. In addition, the format and layout of the interface are not limited thereto, and may be changed by a user.

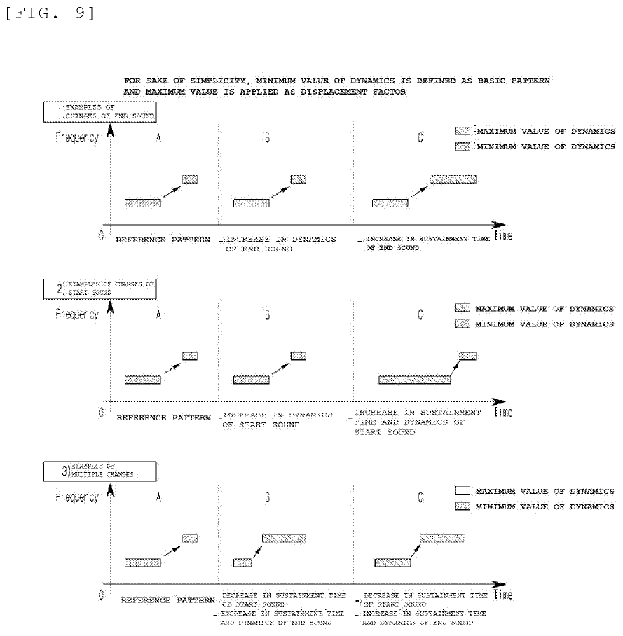

To implement the bidirectional communication services for animals according to the present invention, an animal sound translation algorithm based on a theory of harmony will be described with reference to FIGS. 7 to 16. Hereinafter, for convenience of description, a communication subject is limited to a dog, but the present invention is not limited to the types of communication subjects.

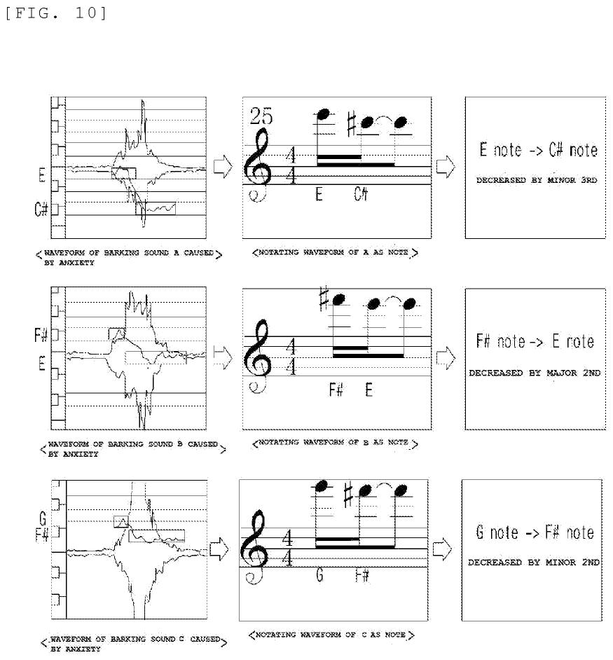

FIG. 7 is a graph for explaining a pre-transposition process in an animal sound translation algorithm of the bidirectional communication service for animals according to one embodiment of the present invention, FIG. 8 is a graph for explaining a transposition process in an animal sound translation algorithm of the bidirectional communication service for animals according to one embodiment of the present invention, and FIG. 9 includes graphs for explaining a process of subdividing emotions depending on dynamics and sustainment time in an animal sound translation algorithm of the bidirectional communication service for animals according to one embodiment of the present invention.

Referring to FIG. 7, notes, intervals, scales, and transposition, which are parts of music, are used for patterning of the sounds of a dog. In this case, notes, intervals, and scales may be used to analyze the emotions of a dog, and transposition may be used for standardization because reference tone is different for each breed.

Animal sounds have a sine waveform, and has the same characteristics as sounds that occur in nature. Among the features of animal sounds, there is continuous instability. That is, animal sounds within an audible frequency range (16 Hz to 20 kHz) are perceived as partially stable sounds rather than as continuous unstable sounds. Accordingly, in an embodiment of the present invention, a process of recognizing unstable animal sounds as stable sounds may be referred to as quantization, and concepts related to a theory of harmony are introduced to analyze the patterns of quantized animal sounds and emotional expressions.

In addition, an animal makes sounds for a specific purpose or to express emotions. Among animal sounds, a reference animal sound is set as a tonic, and animal sounds are listed in order according to frequencies thereof and analyzed using concepts of intervals and scales.

In addition, in modern music, based on 1 octave (do->do, second overtone), 12 scales (chromatic scale−harmonic chromatic scale) are used. There are infinite frequency changes in an expression process, but 12 scales may be explained by a resonance principle using circle of fifth. For example, when various sounds of a dog are analyzed, the lowest and highest notes that are judged to be meaningful may be found. The scales of the quantized sounds of a dog may be formed in the frequency range of these two notes, which are related with the voice characteristics of the dog.

In addition, according to a theory of harmony, transposition indicates that only the pitches of scales change while the characteristics of the scales are maintained. The frequency range of scales varies depending on the size (weight) or breed of a dog.

For normalization of animal sound patterns and emotional expressions, animal sounds are classified into frequency bands according to breed and size (weight). The animal sounds are represented by scales, and transposition of the scales is performed using the same composition to analyze the animal sounds. Accordingly, to classify and analyze animal sound patterns and emotional expressions, quantized notes, increase and decrease in notes, the lowest note and the highest note, specific notes for each breed, and the like are firstly detected and analyzed. In addition, animal sounds are analyzed through comparison and combination of data, and animal emotions are subdivided according to the dynamics and sustainment time of the animal sounds, which will be described in detail with reference to FIG. 9.

In this case, a note is defined as a vibration frequency based on 12 scales of music. Based on this, the sound (frequency) of a dog may be quantized as a note.

In addition, an interval refers to the pitch difference between two notes, and may be a feature that distinguishes the patterns of the sounds of a dog.

In addition, a scale is defined as a sum of notes arranged in order according to pitch with respect to a tonic. In this case, notes may be obtained by patterning a plurality of sounds that a dog can produce, scales may be made using the notes, and the scales may be a standard element for analyzing various dog sounds.

Finally, referring to FIG. 8, transposition refers to a process of moving a collection of notes up or down in pitch. In this case, since the characteristics of the vocal cords are different for each dog, the reference notes of the scaled dog sounds may be different from each other. However, when a reference note is transposed, scales may be standardized.

Referring to FIG. 9, patterns may be subdivided by the dynamics and sustainment time of scales. That is, depending on the intensity and sustainment time of whole notes or each note in a certain pattern of intervals, the emotional states of a dog may be subdivided. For example, when the emotion of a dog is distinguished as pleasure through notes, intervals, scales, and transposition, it is difficult to judge the degree of pleasure.

Accordingly, based on dynamics and sustainment time, the degree of pleasure may be subdivided into upper, middle, and lower.

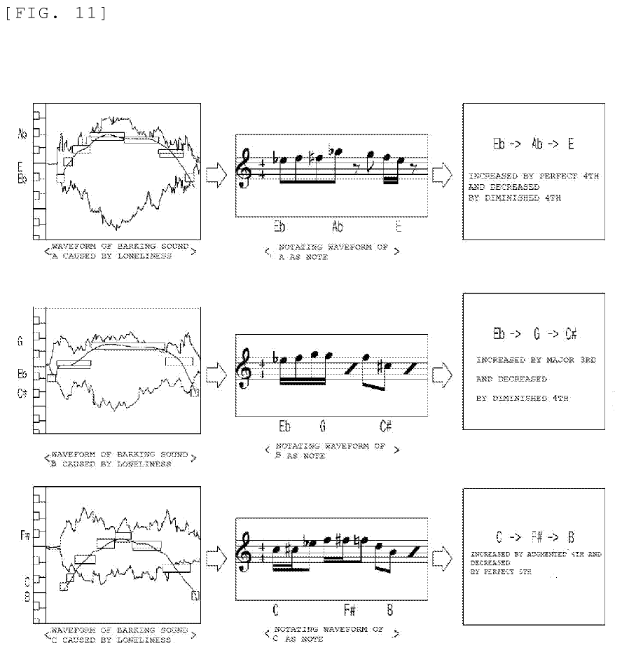

Hereinafter, a method of analyzing patterns from sounds of a dog through notes, intervals, scales, and transposition will be described in detail with reference to FIGS. 10 to 15.

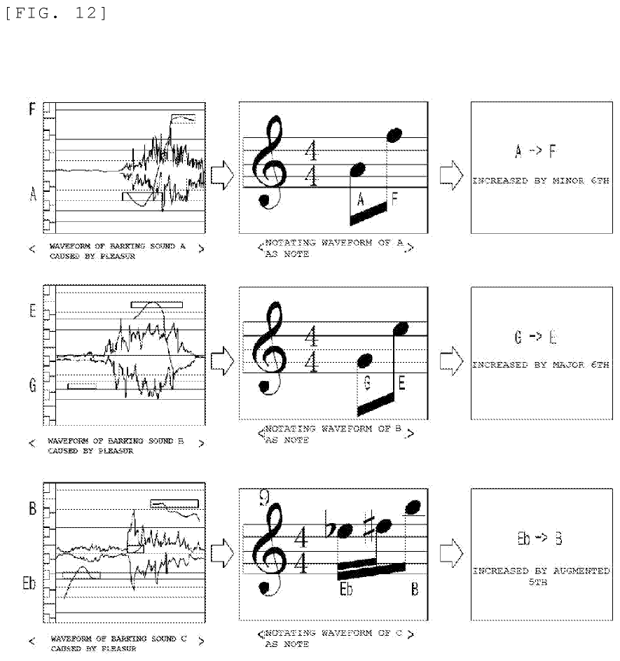

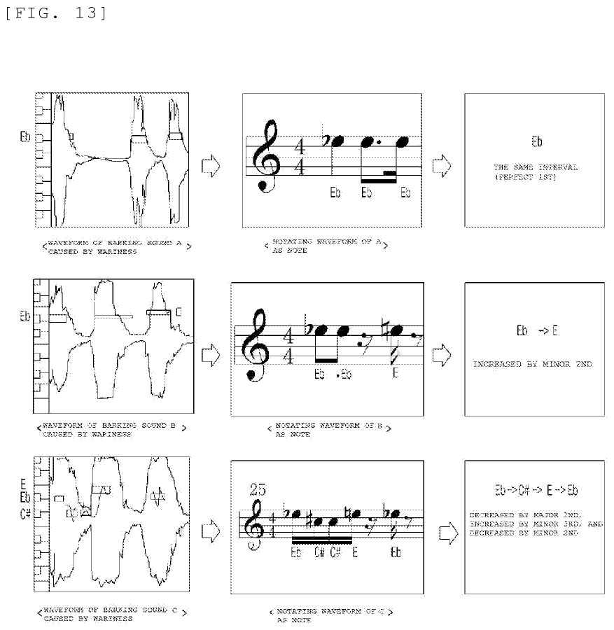

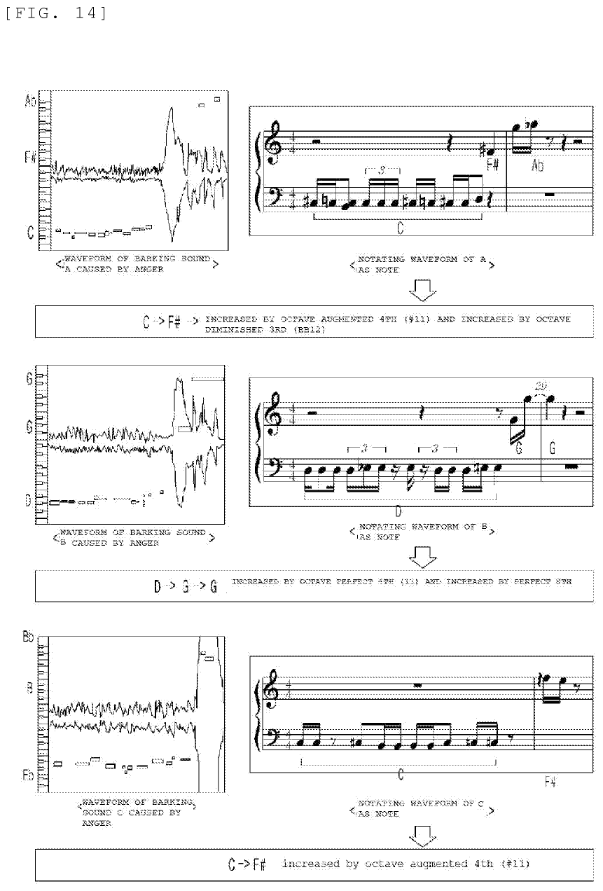

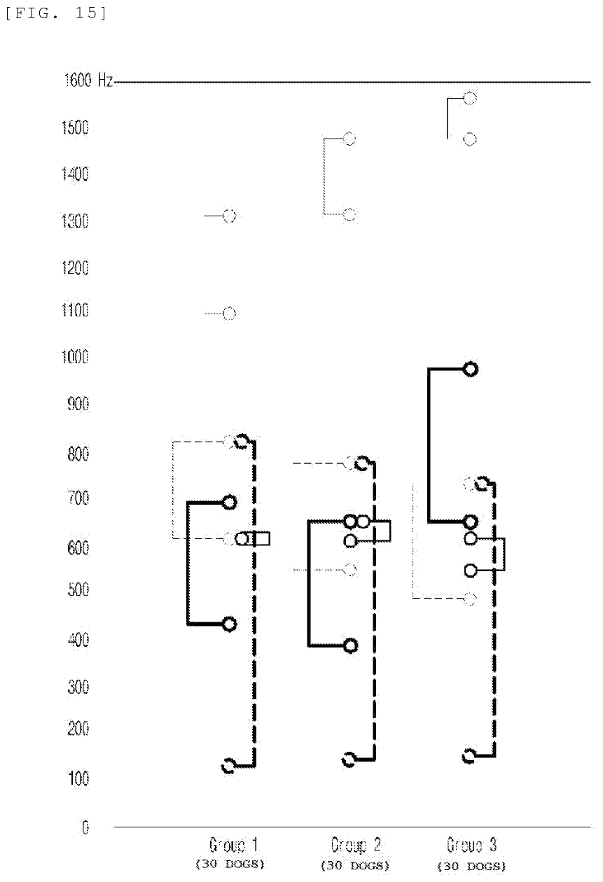

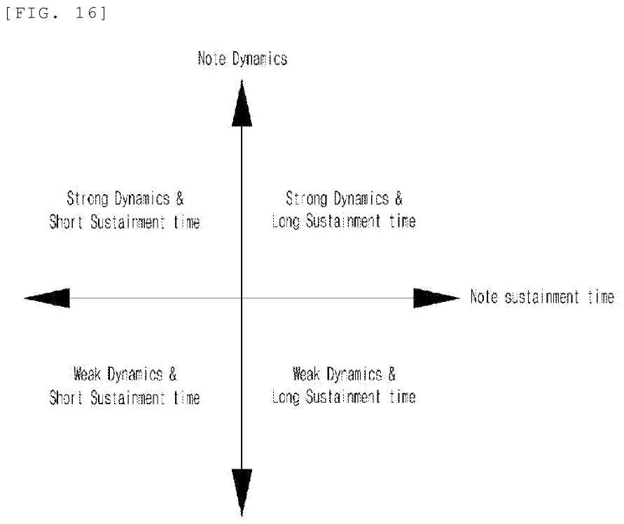

FIG. 10 includes drawings for explaining waveforms and notes for distinguishing emotions of anxiety in an animal sound translation algorithm of the bidirectional communication service for animals according to one embodiment of the present invention, FIG. 11 includes drawings for explaining waveforms and notes for distinguishing emotions of loneliness in an animal sound translation algorithm of the bidirectional communication service for animals according to one embodiment of the present invention, FIG. 12 includes drawings for explaining waveforms and notes for distinguishing emotions of pleasure in an animal sound translation algorithm of the bidirectional communication service for animals according to one embodiment of the present invention, FIG. 13 includes drawings for explaining waveforms and notes for distinguishing emotions of wariness in an animal sound translation algorithm of the bidirectional communication service for animals according to one embodiment of the present invention, FIG. 14 includes drawings for explaining waveforms and notes for distinguishing emotions of anger in an animal sound translation algorithm of the bidirectional communication service for animals according to one embodiment of the present invention, and FIG. 15 is a drawing for explaining frequency ranges according to emotions in an animal sound translation algorithm of the bidirectional communication service for animals according to one embodiment of the present invention.

To pattern the sounds of a dog, the sounds of dogs of different breeds were recorded in five different situations. In this case, the situations may include anxiety, loneliness, pleasure, wariness, and anger. In addition, to analyze the recorded audio, intervals were measured using Logix Pro X.

First, an animal sound translation algorithm may include a preprocessing process of searching for an animal voice (crying sound) recognition target region and removing and recognizing noise components. Then, animal sounds may be expressed as notes, intervals, and scales, which are a part of music, and normalization and patterning may be performed using transposition.

Referring to FIG. 10, the waveforms of barking sounds caused by anxiety and the results of notating the waveforms as notes are shown. Referring to FIG. 10, the three types of barking sounds caused by anxiety may be represented by notes as follows. First, an interval obtained when the waveform of A is notated as a note is decreased by minor 3rd from an E note to a C# note. In addition, an interval obtained when the waveform of B is notated as a note is decreased by major 2nd from an F# note to an E note. In addition, an interval obtained when the waveform of C is notated as a note is decreased by minor 2nd from a G note to an F# note.

Therefore, in the case of barking sounds caused by anxiety, A, B, and C all exhibit similar changes (i.e., decrease within minor 3rd), and the frequency bands range from 1,108.8 Hz to 1,568 Hz. In addition, the minimum decrease in the interval is minor 2nd, and the maximum decrease in the interval is minor 3rd.

Referring to FIG. 11, the waveforms of barking sounds caused by loneliness and the results of notating the waveforms as notes are shown. Referring to FIG. 11, the three types of barking sounds caused by loneliness may be represented by notes as follows. An interval obtained when the waveform of A is notated as a note is increased by perfect 4th from Eb to Ab, and then decreased by diminished 4th from Ab to E. In addition, an interval obtained when the waveform of B is notated as a note is increased by major 3rd from Eb to G, and then decreased by diminished 4th from G to C. In addition, an interval obtained when the waveform of C is notated as a note is increased by augmented 4th from C to F#, and then decreased by perfect 5th from F# to B.

Therefore, in the case of barking sounds caused by loneliness, the intervals of A, B, and C are increased by perfect 4th and decreased by less than perfect 5th, and the frequency bands range from 493.0 Hz to 830.7 Hz. In addition, the minimum decrease in the interval is diminished 4th, and the maximum decrease in the interval is perfect 5th, showing decrease after increase.

Referring to FIG. 12, the waveforms of barking sounds caused by pleasure and the results of notating the waveforms as notes are shown. Referring to FIG. 12, the three types of barking sounds caused by pleasure may be represented by notes as follows. An interval obtained when the waveform of A is notated as a note is increased by minor 6th from A to F, and an interval obtained when the waveform of B is notated as a note is increased by major 6th from G to E. In addition, an interval obtained when the waveform of C is notated as a note is increased by augmented 5th from Eb to B.

Therefore, in the case of barking sounds caused by pleasure, A, B, and C exhibit increase within major 6th within an error range of a chromatic interval, and the frequency bands range from 392 Hz to 987.8 Hz. In addition, the minimum increase in the interval is augmented 5th, and the maximum increase in the interval is major 6th.

Referring to FIG. 13, the waveforms of barking sounds caused by wariness and the results of notating the waveforms as notes are shown. Referring to FIG. 13, the three types of barking sounds caused by wariness may be represented by notes as follows. An interval obtained when the waveform of A is notated as a note is not changed (perfect 1st) at Eb, and an interval obtained when the waveform of B is notated as a note is increased by minor 2nd from Eb to E. In addition, an interval obtained when the waveform of C is notated as a note is decreased by major 2nd from Eb to C#, increased by minor 3rd from C# to E, and then decreased by minor 2nd from E to Eb.

Therefore, in the case of barking sounds caused by wariness, the waveforms of A, B, and C all exhibit the same interval within an error range of a perfect interval, and the frequency bands range from 554.4 Hz to 659.3 Hz. In addition, the minimum change in the interval is perfect 1st, and the maximum increase in the interval is minor 3rd.

Referring to FIG. 14, the waveforms of barking sounds caused by anger and the results of notating the waveforms as notes are shown. Referring to FIG. 14, the three types of barking sounds caused by anger may be represented by notes as follows. An interval obtained when the waveform of A is notated as a note is increased by octave augmented 4th (#11) from C to F#, and then increased by octave diminished 3rd (bb12) from F# to Ab. In addition, an interval obtained when the waveform of B is notated as a note is increased by octave perfect 4th (11) from D to G, and then increased by perfect 8th from G to G. In addition, an interval obtained when the waveform of C is notated as a note is increased by octave augmented 4th (#11) from C to F.

Therefore, in the case of barking sounds caused by anger, in the first change, the waveforms of A, B, and C exhibit a high interval change of octave perfect 4th or more, and in the second change, the waveforms of A and B exhibit a high interval change of perfect 8th or more. In this case, the frequency bands range from 130.8 Hz to 987.4 Hz. In addition, the minimum increase in the interval is octave augmented 4th, and the maximum increase in the interval is two-octave minor 6th. In this case, an unstable interval change is observed in contrast to the case of sounds caused by wariness.

Referring to FIG. 15, the average frequency ranges of the sound patterns according to the five emotions described in FIGS. 10 to 14 are shown. In this case, barking sounds caused by anxiety are designated by \textcircled{1}, barking sounds caused by loneliness are designated by \textcircled{2}, barking sounds caused by pleasure are designated by \textcircled{3}, barking sounds caused by wariness are designated by \textcircled{4}, and barking sounds caused by anger are designated by \textcircled{5}. By analyzing the frequency range and waveform of each case, emotional changes may be grasped for each case.

Table 1 below summarizes the frequency bands, the minimum intervals, the maximum intervals, and increase or decrease in intervals according to the above-described emotions.

TABLE 1

| | | | | | Increase/ |
|---|---|---|---|---|---|
| | Sound | Frequency | Minimum | Maximum | decrease |
| Number | type | band | interval | interval | of note |
| 1 | Anxiety | 1,108.8 Hz to | Minor 2nd | Minor 3rd | Decrease |
| | | 1,568 Hz | | | |
| 2 | Loneli- | 493.0 Hz to | Diminished | Perfect 5th | In- |
| | ness | 830.7 Hz | 4th | | crease −> |
| | | | | | Decrease |
| 3 | Pleasure | 392.0 Hz to | Augmented | Major 6th | Increase |
| | | 987.8 Hz | 5th | | |
| 4 | Wari- | 554.4 Hz to | Perfect 1st | Minor 3rd | Increase |
| | ness | 659.3 Hz | | | |
| 5 | Anger | 130.8 Hz to | Octave | Two- | Increase |
| | | 987.4 Hz | augmented | octave | |
| | | | 4th | minor 6th | |

In describing the method of providing bidirectional communication services for animals, matters not described in FIGS. 2 to 15 are the same as those described in FIG. 1 or may be easily deduced from the description of FIG. 1, and thus a description thereof will be omitted.

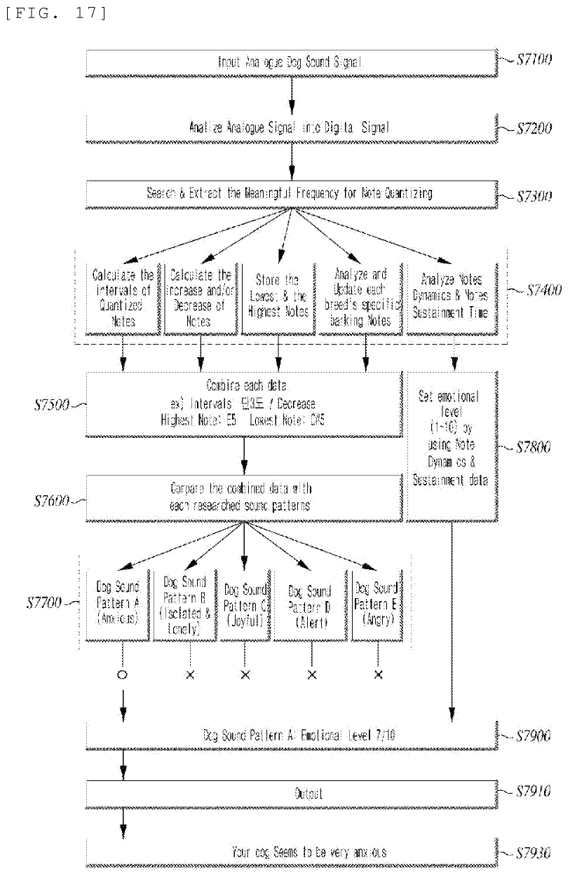

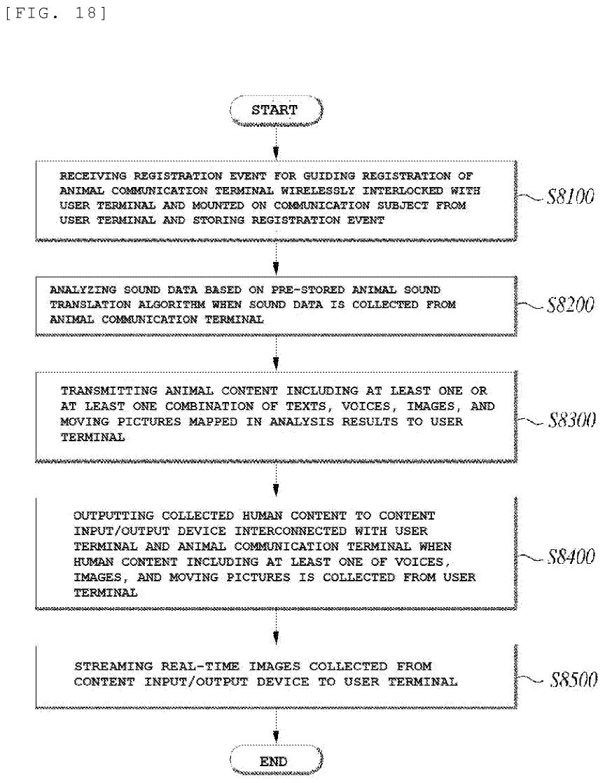

FIG. 16 is a drawing for explaining emotions and sound patterns in the bidirectional communication service for animals according to one embodiment of the present invention, and FIG. 17 is an operation flowchart for explaining an embodiment for extracting emotions of depression using an animal sound translation algorithm of the bidirectional communication service for animals according to one embodiment of the present invention.

Referring to FIG. 16, sounds may be subdivided into four patterns according to interval dynamics and sustainment time. That is, the four patterns may include a case of strong dynamics and long sustainment time, a case of weak dynamics and long sustainment time, a case of strong dynamics and short sustainment time, and a case of weak dynamics and short sustainment time.

The degree of animal's aggressiveness (temperament) may be determined according to the sustainment time of animal sounds. In addition, it may be determined whether the emotional expression of an animal is vigorous or mild according to differences in intervals of animal sounds. That is, a function capable of analyzing the deviation of intervals expressing emotions may be stored by mathematically calculating sustainment time and differences in intervals for each interval. Accordingly, the results of analyzing matched animal emotions may be output as content such as images, text, voice for the text, and moving pictures through the animal communication terminal 100.

Referring to FIG. 17, when the sounds of a dog are input through the animal communication terminal 100 (S7100), the input analog dog sounds are converted into digital signals in the user terminal 400 or the animal bidirectional communication service providing server 300 (S7200), and preprocessing is performed to distinguish the signals from noises (S7200). In this case, the subject that processes the signals may be the animal communication terminal 100, the user terminal 400, or the animal bidirectional communication service providing server 300 according to various embodiments. Thus, description of the subject will be omitted.

Next, a process of distinguishing the dog sounds from noises is performed (S7300). The interval of a quantized note is calculated, increase/decrease in the note is calculated, the minimum and maximum notes are stored, sounds input according to specific types of barking sounds are analyzed, and emotions analyzed according to dynamics and sustainment time are subdivided and analyzed (S7400).

For example, when each set of data is summarized, when an interval is decreased by minor 3rd, the maximum note is E5, and the minimum note is C#5 (S7500), pre-stored patterns and data are compared, and analysis is performed to match the comparison results with types of emotions (S7600).

In this case, as a result of comparison, when the similarity with the pre-stored pattern in the case of anxiety exceeds the predetermined similarity (S7700), by confirming the level of the emotion, that is, the degree of anxiety, through 57800, the type of the emotion is analyzed, and then the degree of the emotion is analyzed (S7900).

In addition, the analyzed results are output (S7910), and the analyzed results and content such as pre-mapped text, images, and moving pictures are output in the user terminal 400 (S7930).

The order between the above-described steps (S7100 to S7930) is merely an example, and the present invention is not limited thereto. That is, the order of the above-described steps (S7100 to S7930) may be interchanged, and some of these steps may be executed at the same time or deleted.

In describing the method of providing bidirectional communication services for animals, matters not described in FIGS. 16 and 17 are the same as those described in FIGS. 1 to 15 or may be easily deduced from the description of FIGS. 1 to 15, and thus a description thereof will be omitted.

FIG. 18 is an operation flowchart for explaining a method of providing bidirectional communication services for animals according to one embodiment of the present invention. Referring to FIG. 18, the animal bidirectional communication service providing server receives a registration event for guiding registration of an animal communication terminal, which is wirelessly interconnected with a user terminal and mounted on a communication subject, from the user terminal and stores the registration event (S8100).

In addition, when sound data is collected from the animal communication terminal, the animal bidirectional communication service providing server analyzes the sound data based on a pre-stored animal sound translation algorithm (S8200).

In addition, the animal bidirectional communication service providing server transmits animal content including at least one or at least one combination of text, voice, images, and moving pictures, which are mapped in analysis results, to the user terminal (S8300).

In addition, when human content including at least one of voice, images, and moving pictures is collected from the user terminal, the animal bidirectional communication service providing server outputs the collected human content to the content input/output device 600 interconnected with the user terminal and the animal communication terminal (S8400).

Finally, the animal bidirectional communication service providing server streams real-time images collected from the content input/output device 600 to the user terminal (S8500).

In describing the method of providing bidirectional communication services for animals, matters not described in FIG. 18 are the same as those described in FIG. 1 to FIG. 17 or may be easily deduced from the description of FIG. 1 to FIG. 17, and thus a description thereof will be omitted.

The method of providing bidirectional communication services for animals according to one embodiment described with reference to FIG. 18 may be implemented in the form of a recording medium including instructions executable by a computer, such as an application or a program module executed by a computer. Computer-readable media may be any available media that may be accessed by a computer, and may include volatile and nonvolatile media and removable and non-removable media. In addition, the computer-readable media may include both computer storage media and communication media. The computer storage media includes volatile and nonvolatile media and removable and non-removable media implemented by any method or technology for storage of information, such as computer readable instructions, data structures, program modules, and other data. The communication media typically includes computer-readable instructions, data structures, program modules, other data of a modulated data signal such as a carrier wave, and other transport mechanisms, and includes any information delivery media.

The method of providing bidirectional communication services for animals according to one embodiment of the present invention may be executed by an application installed in a terminal by default. Here, the application may include a program included in a platform or an operating system that is basically installed in the terminal. In addition, the method may be executed by an application (i.e., program) directly installed on a master terminal by a user via an application store server and an application providing server such as a web server associated with the service and the application. Therefore, the method of providing bidirectional communication services for animals according to one embodiment of the present invention may be implemented by an application (i.e., program) basically installed in a terminal or directly installed by a user, and may be recorded on a computer-readable recording medium such as a terminal.

The aforementioned description of the present invention is provided by way of example and those skilled in the art will understood that the present invention can be easily changed or modified into other specified forms without change or modification of the technical spirit or essential characteristics of the present invention. Therefore, it should be understood that the aforementioned examples are only provided by way of example and not provided to limit the present invention. For example, each of constituents described as a single form may be separately implemented and, similarly, constituents described as being separated may be implemented in a combined form.

It should be understood that the scope of the present invention is defined by the following claims and the invention is to cover all modifications, equivalents, and alternatives falling within the spirit and scope of the invention as defined by the claims.

1. A method of providing bidirectional communication services for animals based on a theory of harmony, wherein the method is executed on an animal bidirectional communication service providing server and comprises:
a step of receiving a registration event for guiding registration of an animal communication terminal, which is wirelessly interconnected with a user terminal and mounted on a communication subject, from the user terminal and storing the registration event;
a step, in which, when sound data is collected from the animal communication terminal, the sound data is analyzed based on a pre-stored animal sound translation algorithm;
a step of transmitting animal content comprising at least one or at least one combination of text, voice, images, and moving pictures mapped in the analysis results to the user terminal;
a step, in which, when human content comprising at least one of voice, images, and moving pictures is collected from the user terminal, the collected human content is output to a content input/output device interconnected with the user terminal and the animal communication terminal; and
a step of streaming real-time images collected from the content input/output device to the user terminal,
wherein the pre-stored animal sound translation algorithm is an algorithm for detecting and analyzing notes, intervals, and scales of the sound data, performing transposition, and then extracting emotions by comparing with pre-stored reference data of the communication subject; the animal communication terminal is implemented as a wearable device worn by a communication subject; and
wherein the animal communication terminal comprises:
a camera for capturing a view of a direction that the communication subject is viewing and the communication subject;
an RFID module for forming a wireless communication channel using RFID;
a speaker for outputting sounds received by and input to the animal communication terminal;
a microphone for receiving sounds of the communication subject;
a motion recognition sensor for sensing motions of the communication subject;
a sound measurement sensor for distinguishing sounds of the communication subject among sounds received from the microphone and inputting the distinguished sounds; and
a wireless network module for forming a channel for data transmission/reception to/from the user terminal through the content input/output device and wireless communication.

2. A method of providing bidirectional communication services for animals based on a theory of harmony, wherein the method is executed on an animal bidirectional communication service providing server and comprises:
a step of receiving a registration event for guiding registration of an animal communication terminal, which is wirelessly interconnected with a user terminal and mounted on a communication subject, from the user terminal and storing the registration event;
a step, in which, when sound data is collected from the animal communication terminal, the sound data is analyzed based on a pre-stored animal sound translation algorithm;
a step of transmitting animal content comprising at least one or at least one combination of text, voice, images, and moving pictures mapped in the analysis results to the user terminal;
a step, in which, when human content comprising at least one of voice, images, and moving pictures is collected from the user terminal, the collected human content is output to a content input/output device interconnected with the user terminal and the animal communication terminal; and
a step of streaming real-time images collected from the content input/output device to the user terminal,
wherein the pre-stored animal sound translation algorithm is an algorithm for detecting and analyzing notes, intervals, and scales of the sound data, performing transposition, and then extracting emotions by comparing with pre-stored reference data of the communication subject,
wherein the emotions comprise anxiety, loneliness, pleasure, wariness, and anger,
wherein a frequency band comprised in reference data for anxiety is 1,108.8 Hz to 1,568 Hz, and an interval comprised in the reference data for anxiety is decreased by minor 2nd to minor 3rd with respect to an initial note;
a frequency band comprised in reference data for loneliness is 493 Hz to 830.7 Hz, and an interval comprised in the reference data for loneliness is increased by major 3rd to perfect 4th with respect to an initial note and then is decreased by diminished 4th to perfect 5th;
a frequency band comprised in reference data for pleasure is 392 Hz to 987.8 Hz, and an interval comprised in the reference data for pleasure is increased by augmented 5th to major 6th with respect to an initial note;
a frequency band comprised in reference data for wariness is 554.4 Hz to 659.3 Hz, and an interval comprised in the reference data for wariness is increased by perfect 1st to minor 3rd with respect to an initial note; and
a frequency band comprised in reference data for anger is 130.8 Hz to 987.4 Hz, and an interval comprised in the reference data for anger is increased by perfect 4th or more with respect to an initial note and is further increased by perfect 8th or more with respect to the increased note.

3. The method according to claim 1, wherein the pre-stored animal sound translation algorithm extracts the emotions and then analyzes the emotions and temperament changes according to differences in intervals, sustainment time, and dynamics.

4. The method according to claim 1, wherein the user terminal stores input and output data for stimulation and response between the user and the communication subject, and performs patterning of the stored data through machine learning, deep learning, or artificial intelligence neural network learning,
wherein, when the patterned output data is input from the animal communication terminal, the user terminal outputs communication content matched with the output data, and patterning of the input data and the output data is executable on the animal bidirectional communication service providing server.

5. A method of providing bidirectional communication services for animals based on a theory of harmony, wherein the method is executed on an animal bidirectional communication service providing server and comprises:
a step of receiving a registration event for guiding registration of an animal communication terminal, which is wirelessly interconnected with a user terminal and mounted on a communication subject, from the user terminal and storing the registration event;
a step, in which, when sound data is collected from the animal communication terminal, the sound data is analyzed based on a pre-stored animal sound translation algorithm;
a step of transmitting animal content comprising at least one or at least one combination of text, voice, images, and moving pictures mapped in the analysis results to the user terminal;
a step, in which, when human content comprising at least one of voice, images, and moving pictures is collected from the user terminal, the collected human content is output to a content input/output device interconnected with the user terminal and the animal communication terminal; and
a step of streaming real-time images collected from the content input/output device to the user terminal,
wherein the pre-stored animal sound translation algorithm is an algorithm for detecting and analyzing notes, intervals, and scales of the sound data, performing transposition, and then extracting emotions by comparing with pre-stored reference data of the communication subject;
the animal communication terminal comprises a GPS module, a frequency measurement sensor module, and an oscillation module; and
when the animal communication terminal is located at a predetermined position or is adjacent to an insect generating a predetermined frequency, the animal communication terminal outputs two or more frequencies of 20 kHz to 20 MHz per second using the oscillation module,
wherein the output frequencies do not cancel each other out, and are oscillated in a multidirectional manner.

6. The method according to claim 1, wherein, when a loss event of a communication subject wearing the animal communication terminal is displayed on the user terminal, the animal bidirectional communication service providing server transmits loss content to the animal communication terminal so that the animal communication terminal outputs the loss content,
wherein the loss content comprises a name of the communication subject, a telephone number of the user terminal, and an address, and is output in a predetermined period or in real time.

7. A method of providing bidirectional communication services for animals based on a theory of harmony, wherein the method is executed on an animal bidirectional communication service providing server and comprises:
a step of receiving a registration event for guiding registration of an animal communication terminal, which is wirelessly interconnected with a user terminal and mounted on a communication subject, from the user terminal and storing the registration event;
a step, in which, when sound data is collected from the animal communication terminal, the sound data is analyzed based on a pre-stored animal sound translation algorithm;
a step of transmitting animal content comprising at least one or at least one combination of text, voice, images, and moving pictures mapped in the analysis results to the user terminal;
a step, in which, when human content comprising at least one of voice, images, and moving pictures is collected from the user terminal, the collected human content is output to a content input/output device interconnected with the user terminal and the animal communication terminal; and
a step of streaming real-time images collected from the content input/output device to the user terminal,
wherein the pre-stored animal sound translation algorithm is an algorithm for detecting and analyzing notes, intervals, and scales of the sound data, performing transposition, and then extracting emotions by comparing with pre-stored reference data of the communication subject, and the animal communication terminal comprises a light emitting device, a solar power generation module, and a kinetic energy generation module,
wherein, when a measured illuminance is less than a predetermined illuminance, the solar power generation module and the kinetic energy generation module allow the light emitting device to emit light, and intensity of the emitted light is adjusted in the user terminal.

8. The method according to claim 1, wherein the animal communication terminal comprises a display panel,
wherein, when input sound data is translated by the pre-stored animal sound translation algorithm, the animal communication terminal outputs a type and intensity of a translated emotion as content comprising colors, phrases, images, and moving pictures, which have been mapped and stored, and the output content is displayed on the display panel.

9. A method of providing bidirectional communication services for animals based on a theory of harmony, wherein the method is executed on an animal bidirectional communication service providing server and comprises:
a step of receiving a registration event for guiding registration of an animal communication terminal, which is wirelessly interconnected with a user terminal and mounted on a communication subject, from the user terminal and storing the registration event;
a step, in which, when sound data is collected from the animal communication terminal, the sound data is analyzed based on a pre-stored animal sound translation algorithm;
a step of transmitting animal content comprising at least one or at least one combination of text, voice, images, and moving pictures mapped in the analysis results to the user terminal;
a step, in which, when human content comprising at least one of voice, images, and moving pictures is collected from the user terminal, the collected human content is output to a content input/output device interconnected with the user terminal and the animal communication terminal; and
a step of streaming real-time images collected from the content input/output device to the user terminal,
wherein the pre-stored animal sound translation algorithm is an algorithm for detecting and analyzing notes, intervals, and scales of the sound data, performing transposition, and then extracting emotions by comparing with pre-stored reference data of the communication subject; and
the animal communication terminal comprises a camera and a biometric sensor,
wherein, when a medical care request event is displayed on the user terminal, pre-stored data of the animal communication terminal and data measured by the biometric sensor are transmitted to a veterinarian terminal of a veterinarian treating the communication subject via the animal bidirectional communication service providing server, and the veterinarian terminal controls a capturing direction of the camera comprised in the animal communication terminal, receives captured images in real time, and transmits feedback to the user terminal.

10. A method of providing bidirectional communication services for animals based on a theory of harmony, wherein the method is executed on an animal bidirectional communication service providing server and comprises:
a step of receiving a registration event for guiding registration of an animal communication terminal, which is wirelessly interconnected with a user terminal and mounted on a communication subject, from the user terminal and storing the registration event;
a step, in which, when sound data is collected from the animal communication terminal, the sound data is analyzed based on a pre-stored animal sound translation algorithm;
a step of transmitting animal content comprising at least one or at least one combination of text, voice, images, and moving pictures mapped in the analysis results to the user terminal;
a step, in which, when human content comprising at least one of voice, images, and moving pictures is collected from the user terminal, the collected human content is output to a content input/output device interconnected with the user terminal and the animal communication terminal; and a step of streaming real-time images collected from the content input/output device to the user terminal,
wherein the pre-stored animal sound translation algorithm is an algorithm for detecting and analyzing notes, intervals, and scales of the sound data, performing transposition, and then extracting emotions by comparing with pre-stored reference data of the communication subject; and
the animal communication terminal, the user terminal, and the animal bidirectional communication service providing server are interconnected based on a cloud server,
wherein the animal bidirectional communication service providing server performs data mining and learning of collected data using big data to store categorized patterns for each type, predicts diseases of a communication subject, and transmits a prediction result to the user terminal.

11. The method according to claim 9, wherein the animal communication terminal is installed in each sector within audible limits to extract a signal pattern according to a predetermined sound in an animal breeding facility; and
to monitor animals in real time for disease prevention and early disease detection, when a cough sound indicating illness, an onomatopoeic sound, a mutual communication sound, or a sound indicating pain among a plurality of animal sounds has a sound signal pattern identical to a specific sound signal pattern, the animal communication terminal extracts the sound.
